(19) United States
(12) Patent Application Publication
(10) Pub. No.: US 2020/0412283 A1
(43) Pub. Date: Dec. 31, 2020

(54) METHOD FOR GENERATING CONTROL SIGNAL, ELECTRONIC DEVICE AND STORAGE MEDIUM

(71) Applicant: AAC Technologies Pte. Ltd., Singapore city (SG)

(72) Inventors: Xiang Lu, Shenzhen (CN); Zheng Xiang, Shenzhen (CN)

(21) Appl. No.: 16/994,661

(22) Filed: Aug. 17, 2020

Related U.S. Application Data
(63) Continuation of application No. PCT/CN2019/093078, filed on Jun. 30, 2019.

(51) Int. Cl. H02P 6/00; H02P 25/06

(52) U.S. Cl. CPC H02P 6/006; H02P 25/06

(57) ABSTRACT

A method for generating a control signal is provided, including: acquiring a relationship curve between an initial signal and time, and the relationship curve includes several sampling points and a value of the initial signal and the time corresponding to each sampling point; determining whether the value of the initial signal is 0; constructing an optimization function according to the relationship curve if the value of the initial signal is not 0; multiplying the value of the initial signal corresponding to each sampling point by a corresponding value of the optimization function to obtain an optimized value of each sampling point; generating a control signal according to a corresponding relationship between the optimized value and time, where the control signal is used to drive the motor to vibrate. The method for generating control signals of the present disclosure can reduce an oscillation response and improve a user experience.

### TECHNICAL FIELD

The present disclosure relates to communication technology, in particular to a method for generating a control signal, an electronic device and a storage medium.

### BACKGROUND

The vibration feedback with respect to existing electronic devices such as mobile phones, tablet computers, and the like, is an intuitive physical experience which the experiencer feels and which is brought by the work of the touch controller, and diverse experience feedbacks require to be stimulated by different input signals. Many times the input signal is obtained based on the direct output of the touch controller. In order to achieve a certain vibration effect, designers start from the input terminal of the touch controller and inversely derive the input control signal of the touch controller many times. However, in the process of inverse derivation, there is a certain probability that the obtained input control signal will have a nonzero initial point or end point, which means that the control signal does not start from 0. The non-zero start of the excitation signal is equivalent to introducing a step signal into the signal. The current linear excitation motor (LRA) will produce an oscillating response to the step signal, affecting user experience.

Therefore, it is necessary to provide a method for generating a control signal that makes the control signal starts from 0.

### SUMMARY

An objective of the present disclosure is to provide a method for generating a control signal, an electronic device, and a storage medium, so that the control signal starts from 0, and the oscillation response is reduced.

The technical solution of the present disclosure is as follows:

a method for generating a control signal, which includes:

acquiring a relationship curve between an initial signal and time, where the relationship curve includes several sampling points and a value of the initial signal and the time corresponding to each sampling point;

determining whether the value of the initial signal corresponding to the first sampling point of the relationship curve is 0;

constructing an optimization function according to the relationship curve if the value of the initial signal corresponding to the first sampling point of the relationship curve is not 0;

multiplying the value of the initial signal corresponding to each sampling point by a corresponding value of the optimization function to obtain an optimized value of each sampling point;

generating a control signal according to a corresponding relationship between the optimized value and the time, where the control signal is used to drive the motor to vibrate.

Further, the optimization function is: y=1−e^{-λt}, where λ is a fixed value and t is the time.

Further,

$$λ = \frac{2.5}{n} ,$$

where n is the number of the sampling points.

Further, before multiplying the value of the initial signal corresponding to each sampling point by the corresponding value of the optimization function, the method further includes:

normalizing the relationship curve between the initial signal and the time.

Further, the method further includes:

determining whether the value of the initial signal corresponding to the last sampling point of the relationship curve is 0;

arranging the sampling points on the relationship curve in a reverse order if the value of the initial signal corresponding to the last sampling point of the relationship curve is not 0, and multiplying the value of the initial signal corresponding to each sampling point arranged in the reverse order by the corresponding value of the optimization function to obtain the optimized value of each sampling point arranged in the reverse order.

Further, the initial signal is a voltage signal.

The present disclosure further provides an electronic device, including a processor and a memory storing computer readable programs that are configured to be executed by the processor, and that, as a result of being executed by the processor, perform the above-mentioned method.

The present disclosure further provides a computer-readable storage medium storing computer programs that, when being executed by the processor, perform the above method.

The beneficial effects of the present disclosure are as follows: the relationship curve where the value of the initial signal corresponding to the first sampling point is not 0 is optimized to obtain the optimized value of each sampling point by constructing an optimization function, the control signal is generated according to the corresponding relationship between the optimized value and the time, and the control signal with respect to the initial signal with the value of 0 corresponding to the first sampling point is obtained, so as to drive the motor to vibrate, thereby reducing the oscillation response and improving the user experience.

### BRIEF DESCRIPTION OF THE DRAWINGS

FIG. 1 is an application scenario diagram of a method for generating a control signal in embodiments of the present disclosure;

FIG. 2 is a schematic diagram of an electronic device in embodiments of the present disclosure;

FIG. 3 is a flowchart of a method for generating a control signal in the first embodiment of the present disclosure;

FIG. 4 is a diagram of a relationship curve between an initial signal and time in embodiments of the present disclosure;

FIG. 5 is a schematic diagram of a control signal generated by the method in embodiments of the present disclosure.

### DETAILED DESCRIPTION

The present disclosure will be further described below with reference to accompanying drawings and embodiments.

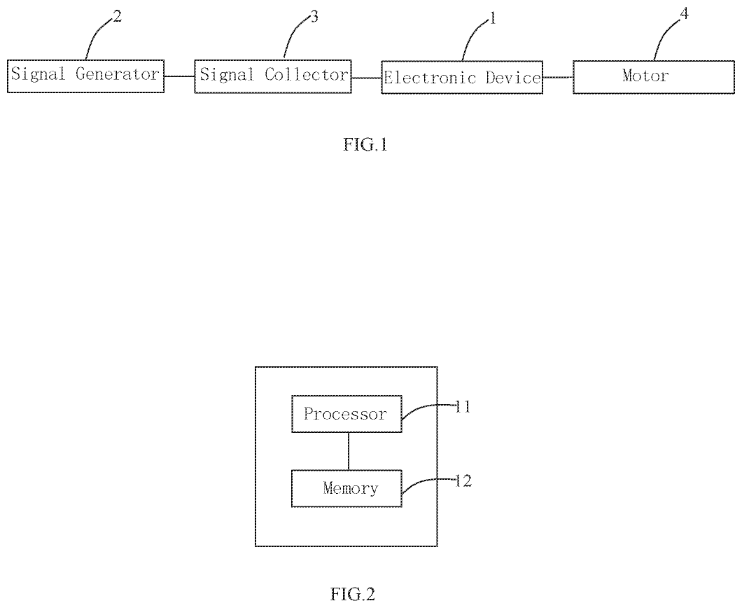

As shown in FIG. 1, the method for generating a control signal in embodiments of the present disclosure is applied to a motor drive system. The motor drive system includes an electronic device 1, a signal generator 2, a signal collector 3 and a motor 4. The signal generator 2 generates a driving signal, the signal collector 3 collects the driving signal and generates a relationship curve between an initial signal and time. The electronic device 1 drives the motor 4 to vibrate after processing the relationship curve between the initial signal and the time.

As shown in FIG. 2, the electronic device in embodiments of the present disclosure includes a processor 11 and a memory 12. The memory 12 stores computer-readable programs which are configured to be executed by the processor 11. The computer-readable programs, when being executed by the processor 11, perform the following method.

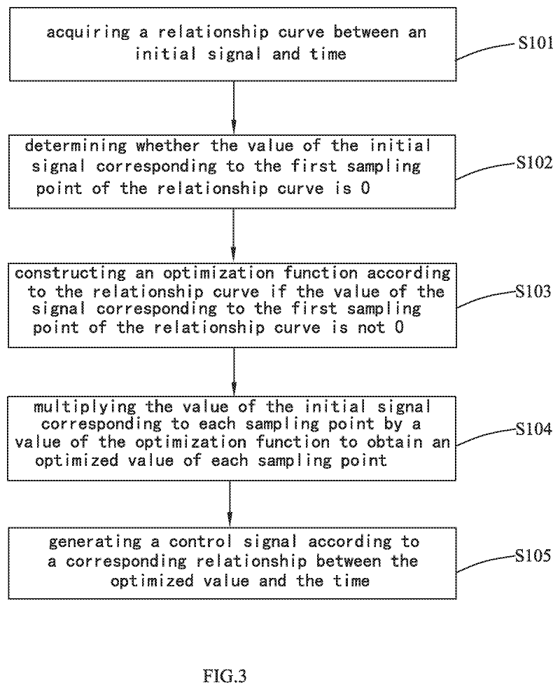

As shown in FIG. 3, the method for generating a control signal in the first embodiment of the present disclosure includes:

In step S101, a relationship curve between the initial signal and the time is acquired, and the relationship curve includes several sampling points and a value of the initial signal and the time corresponding to each sampling point.

The relationship curve between the initial signal and the time is calculated from the motion parameters of the motor. For example, the relationship curve between the initial signal and the time is calculated according to the relationship between a displacement and the time or an acceleration and the time during the vibration of the motor.

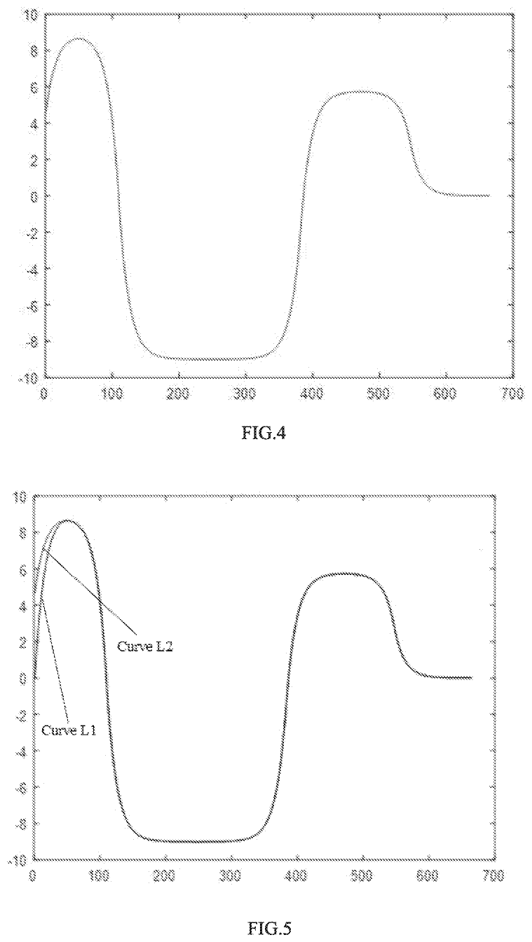

FIG. 4 is a relationship curve between the initial signal and the time, that is, a function of the initial signal with respect to the time. The horizontal coordinate is the time, and the vertical coordinate is the value of the initial signal. In one embodiment, the initial signal is a voltage signal.

In step S102, whether the value of the initial signal corresponding to the first sampling point of the relationship curve is 0 is determined.

The first sampling point is a starting point of the initial signal, that is, the sampling point corresponding to the time of 0. As shown in FIG. 4, the value of the initial signal corresponding to the sampling point corresponding to the time of 0 is not 0.

In step S103, an optimization function is constructed according to the relationship curve if the value of the initial signal corresponding to the first sampling point of the relationship curve is not 0.

The optimization function needs to be a concave function that gradually gets closer to 1 at the beginning, and then becomes a straight line that is infinitely close to 1, that is, the optimized signal initially slowly rises from 0, and then an amplitude of the optimized signal is infinitely close to the original signal.

In one embodiment, the optimization function is: y=1−e^{-λt}, where λ is a fixed value and t is the time. Preferably,

$$λ = \frac{2.5}{n} ,$$

where n is the number of the sampling points. It should be noted that λ may also be set according to the experience value.

In step S104, the value of the initial signal corresponding to each sampling point is multiplied by the corresponding value of the optimization function to obtain the optimized value of each sampling point.

Specifically, the value of the optimization function is calculated according to the time of each sampling point, and multiplied by the value of the initial signal corresponding to the sampling point to obtain the optimized value of the sampling point.

In one embodiment, the relationship curve between the initial signal and the time is first normalized, then a maximum value of the initial signal after being normalized is recorded and multiplied by the optimization function to restore its true value.

In step S105, the control signal is generated according to a corresponding relationship between the optimized value and the time, and the control signal is used to drive the motor to vibrate.

Specifically, each optimized value corresponds to one time, and a functional relationship may be obtained according to the corresponding relationship between the optimized value and the time, and a relationship curve between the optimized value and the time, that is, the control signal, is drawn. As shown in FIG. 5, the curve L1 is the initial signal, the curve L2 is the control signal obtained after the initial signal is optimized by the optimization function. A starting point of the control signal is 0, and the motor is driven by the control signal to reduce an oscillation response and improve a user experience.

In another embodiment, the method for generating a control signal further includes: determining whether the value of the initial signal corresponding to the last sampling point of the relationship curve is 0; arranging the sampling points on the relationship curve in a reverse order if the value of the initial signal corresponding to the last sampling point of the relationship curve is not 0; and multiplying the value of the initial signal corresponding to each sampling point arranged in the reverse order by the corresponding value of the optimization function to obtain the optimized value of each sampling point arranged in the reverse order.

Specifically, the last sampling point of the relationship curve is an end point of the initial signal. If the end point of the initial signal needs to be optimized to 0, the relationship curve between the initial signal and the time is arranged in the reverse order. For example, the value of the initial signal corresponding to each sampling point are arranged in the reverse order to form a functional relationship with respect to the time after being arranged in the reverse order. According to the time corresponding to each sampling point arranged in the reverse order, the value of the optimization function is calculated, and multiplied by the value of the initial signal corresponding to the sampling point to obtain the optimized value of the sampling point, that is, the optimized value of each sampling point arranged in the reverse order. The optimized value of each sampling point arranged in the reverse order is arranged in the reverse order again, forming a relationship curve with respect to time. That is, the control signal is obtained, so that the control signal with the end point of 0 is obtained, thereby reducing the oscillation response and improving the user experience.

The electronic device in the embodiments of the present disclosure and the method in the above embodiment are two aspects based on the same inventive concept. An implementation process of the method has been described in details above, so those skilled in the art may clearly understand the implementation process of the electronic device in this embodiment according to the above description. For the sake of conciseness of the description, it will not be repeated herein.

It can be known from the description of the above embodiments that those skilled in the art may clearly understand that the present disclosure may be implemented by means of software plus a necessary general hardware platform. Based on this understanding, the technical solution of the present disclosure, or part of the present disclosure that makes contributions to existing technologies, may be embodied in the form of software products in essence. The present disclosure also relates to a computer-readable storage medium, such as ROM/RAM, a magnetic disk, an optical disk, and the like, on which computer programs are stored, and the computer programs, when executed by a processor, perform the above method.

The method for generating a control signal, the electronic device and the storage medium in the present disclosure optimize the relationship curve where the value of the initial signal corresponding to the first sampling point is not 0 by constructing an optimization function to obtain the optimized value of each sampling point. The control signal is generated according to the corresponding relationship between the optimized value and the time, and the control signal with the initial signal of 0 corresponding to the first sampling point is obtained to drive the motor to vibrate, thereby reducing the oscillation response and improving the user experience.

The above are only embodiments of the present disclosure. It should be indicated that those of ordinary skill in the art can make improvements without departing from the inventive concept of the present disclosure, and such improvements belong to the protection scope of the present disclosure.

What is claimed is:

1. A method for generating a control signal, comprising:
acquiring a relationship curve between an initial signal and time, where the relationship curve comprises several sampling points and a value of the initial signal and the time corresponding to each sampling point;
determining whether the value of the initial signal corresponding to the first sampling point of the relationship curve is 0;
constructing an optimization function according to the relationship curve if the value of the initial signal corresponding to the first sampling point of the relationship curve is not 0;
multiplying the value of the initial signal corresponding to each sampling point by a corresponding value of the optimization function to obtain an optimized value of each sampling point;
generating a control signal according to a corresponding relationship between the optimized value and the time, wherein the control signal is used to drive the motor to vibrate.

2. The method for generating a control signal according to claim 1, wherein the optimization function is: y=1−e^{-λt}, where λ is a fixed value and t is the time.

3. The method for generating a control signal according to claim 2, wherein:
$$λ = \frac{2.5}{n} ,$$
where n is the number of the sampling points.

4. The method for generating a control signal according to claim 2, wherein before multiplying the value of the initial signal corresponding to each sampling point by the corresponding value of the optimization function, the method further comprises:
normalizing the relationship curve between the initial signal and the time.

5. The method for generating a control signal according to claim 1, wherein the method further comprises:
determining whether the value of the initial signal corresponding to the last sampling point of the relationship curve is 0;
arranging the sampling points on the relationship curve in a reverse order if the value of the initial signal corresponding to the last sampling point of the relationship curve is not 0, and multiplying the value of the initial signal corresponding to each sampling point arranged in the reverse order by the corresponding value of the optimization function to obtain the optimized value of each sampling point arranged in the reverse order.

6. The method for generating a control signal according to claim 1, wherein the initial signal is a voltage signal.

7. An electronic device, comprising a processor and a memory storing computer readable programs that are configured to be executed by the processor, and that, as a result of being executed by the processor, perform a method for generating a control signal, wherein the method comprises:
acquiring a relationship curve between an initial signal and time, where the relationship curve comprises several sampling points and a value of the initial signal and the time corresponding to each sampling point;
determining whether the value of the initial signal corresponding to the first sampling point of the relationship curve is 0;
constructing an optimization function according to the relationship curve if the value of the initial signal corresponding to the first sampling point of the relationship curve is not 0;
multiplying the value of the initial signal corresponding to each sampling point by a corresponding value of the optimization function to obtain an optimized value of each sampling point;
generating a control signal according to a corresponding relationship between the optimized value and the time, wherein the control signal is used to drive the motor to vibrate.

8. The electronic device according to claim 7, wherein the optimization function is: y=1−e^{-λt}, where λ is a fixed value and t is the time.

9. The electronic device according to claim 8, wherein:
$$λ = \frac{2.5}{n} ,$$
where n is the number of the sampling points.

10. The electronic device according to claim 8, wherein before multiplying the value of the initial signal corresponding to each sampling point by the corresponding value of the optimization function, the method further comprises:
normalizing the relationship curve between the initial signal and the time.

11. The electronic device according to claim 7, wherein the method further comprises:
determining whether the value of the initial signal corresponding to the last sampling point of the relationship curve is 0;
arranging the sampling points on the relationship curve in a reverse order if the value of the initial signal corresponding to the last sampling point of the relationship curve is not 0, and multiplying the value of the initial signal corresponding to each sampling point arranged in the reverse order by the corresponding value of the optimization function to obtain the optimized value of each sampling point arranged in the reverse order.

12. The electronic device according to claim 7, wherein the initial signal is a voltage signal.

13. A computer-readable storage medium storing computer programs that, when being executed by the processor, perform a method for generating a control signal, wherein the method comprises:
acquiring a relationship curve between an initial signal and time, where the relationship curve comprises several sampling points and a value of the initial signal and the time corresponding to each sampling point;
determining whether the value of the initial signal corresponding to the first sampling point of the relationship curve is 0;
constructing an optimization function according to the relationship curve if the value of the initial signal corresponding to the first sampling point of the relationship curve is not 0;
multiplying the value of the initial signal corresponding to each sampling point by a corresponding value of the optimization function to obtain an optimized value of each sampling point;
generating a control signal according to a corresponding relationship between the optimized value and the time, wherein the control signal is used to drive the motor to vibrate.

14. The computer-readable storage medium according to claim 13, wherein the optimization function is: y=1−e^{-λt}, where λ is a fixed value and t is the time.

15. The computer-readable storage medium according to claim 14, wherein:
$$λ = \frac{2.5}{n} ,$$
where n is the number of the sampling points.

16. The computer-readable storage medium according to claim 14, wherein before multiplying the value of the initial signal corresponding to each sampling point by the corresponding value of the optimization function, the method further comprises:
normalizing the relationship curve between the initial signal and the time.

17. The computer-readable storage medium according to claim 13, wherein the method further comprises:
determining whether the value of the initial signal corresponding to the last sampling point of the relationship curve is 0;
arranging the sampling points on the relationship curve in a reverse order if the value of the initial signal corresponding to the last sampling point of the relationship curve is not 0, and multiplying the value of the initial signal corresponding to each sampling point arranged in the reverse order by the corresponding value of the optimization function to obtain the optimized value of each sampling point arranged in the reverse order.

18. The computer-readable storage medium according to claim 13, wherein the initial signal is a voltage signal.
